(19) United States
(12) Patent Application Publication
(10) Pub. No.: US 2006/0244768 A1
(43) Pub. Date: Nov. 2, 2006

(54) ENHANCED PERSONALIZED PORTAL PAGE

(75) Inventor: George B. Witwer, Bluffton, IN (US)

Correspondence Address: BINGHAM MCHALE LLP, 2700 MARKET TOWER, 10 WEST MARKET STREET, INDIANAPOLIS, IN, 46204-4900, US

(73) Assignee: HUMANIZING TECHNOLOGIES, INC., Indianapolis, IN (US)

(21) Appl. No.: 11/164,697

(22) Filed: Dec. 1, 2005

Related U.S. Application Data
(63) Continuation-in-part of application No. 10/298,181, filed on Nov. 15, 2002.
(63) Continuation-in-part of application No. 10/298,182, filed on Nov. 15, 2002.
(63) Continuation-in-part of application No. 10/298,183, filed on Nov. 15, 2002.
(63) Continuation-in-part of application No. 10/961,314, filed on Oct. 8, 2004.
(63) Continuation-in-part of application No. 11/064,992, filed on Feb. 24, 2005.

(51) Int. Cl. G09G 5/00

(52) U.S. Cl. 345/661

(57) ABSTRACT

A portal provider hosts personalized portal page that, when loaded by a user's computer, accesses content hosted by a sponsor's and other content servers. The service provider hosts the portal information (but not the content) in exchange for fees from the sponsor and/or users. A set of tabs each provides access to “views,” each displaying content for the user. Certain views and/or tabs have restrictions on actions the user can take on them, while the user can customize others. Views, tabs, and the application can include background images, either behind the content or over it with alpha blending so that the content is simultaneously visible. Users can access a library of pre-made tabs and can reposition pixel views persistently between user sessions. Picture and video views are available, email is exchanged, media files are played, and a local file browser leverages file associations and applications to further personalize the experience.

REFERENCE TO RELATED APPLICATIONS

Subject matter in this application relates to, and priority is claimed to U.S. patent application Ser. Nos. 10/298,181, “Methods and Systems for Implementing a Customized Life Portal” (or “LifePage Application” herein); 10/298,182, “Customized Life Portal”; 10/298,183, “Method and System for Modifying Web Content for Display in a Life Portal”; and 10/961,314, “Clustering-Based Personalized Web Experience”; and 11/064,992, “User-Configurable Multimedia Presentation System.”

### FIELD OF THE INVENTION

The present invention relates generally to Internet application software and web site configuration. More specifically, it relates to a personal portal web site configuration, to modes of retrieving and displaying content and business methods related thereto.

### BACKGROUND

There are presently numerous ways to create custom or personal home pages at high-traffic portals on the Internet, as well as at lesser known web sites. For example, conventional personal portals designed from the “top down” have been available for years, such as “My Yahoo” and “My Excite,” among many other similar user tools and options at other web sites and portals.

However, despite their availability for the last several years, the use of personal home pages at widely used portals has not seen widespread acceptance among a vast majority of Internet users. This is a result, in large degree, to the relative complexity and sophistication required to configure, program, and maintain personal and custom web pages. Moreover, even after overcoming the initial barrier to creating and configuring personal web pages, many users have found that the sites they have created are, indeed, not as personal or customized as they were expecting. Many of them continue having difficulty retrieving and displaying content that is truly targeted to their interests, preferences, and priorities. Thus, for many users, tools for creating personal web sites do not satisfactorily meet their expectations or needs. For example, although a user can create a personal homepage at a portal or portal-type web site, the user often still must pass through several web pages to reach content of interest to the user. In one scenario, a user wanting to check local high school sport scores or check scheduling information for community events may not be able to do so if going through present personal web sites, or a user may have to view multiple pages before reaching the page with the relevant content. As such, the level of customization of user home sites at many portals is not satisfactory.

Furthermore, the content (e.g., local news, sports, weather, specialized subjects, and so on) may not be retrievable from the portal or ISP hosting the user's personal web site. The range of content available may be limited to the content created or hosted by the portal or made available to the portal (e.g., licensed by the portal or ISP), or may otherwise be from a limited range of sources. Typically, the portals and ISPs providing the personalized portal service are content aggregators. However, the amount of content that can be aggregated is necessarily limited because most of the content on the Internet is not available for syndication and, therefore, cannot be collected by third-parties, such as portals. Consequently, content aggregators cannot offer the breadth of content needed to fully meet the content needs of all potential users, each of whom will likely have unique, wide-ranging interests. The sources available to the portal are limited to sources licensed for use by the portal and may not have the content the user wants, thereby restricting the level of customization of the personal web pages.

### SUMMARY

In one embodiment, a personalized web portal includes a tab (also known as a “category”) customized for a sponsor, employer, or other person or entity, so that at least some of the content on the tab is not modifiable by the user. Instead, the “fixed” portion of the content, while not static, is not as subject to the control of the user as other content is. For example, the user cannot delete the fixed content, cover it with other views, or delete the tab entirely. In some forms of this embodiment, this tab (including the fixed content) is also always the first tab to be shown when a user views the portal. In others, the tab containing the fixed content is the only tab available for customization.

In other embodiments, configurability of various features can be controlled as a function of the user profile, group of users, and the like. In one embodiment, administrators can use a “customer portal manager” (CPM) to impose fine-grained control over those permission settings, so that users can or cannot move, delete, refresh, rename, scroll, or set a view's z-order relative to other views on a tab. The CPM enables the administrator to set these permissions by individual, role, or group, or based on administrator-specified criteria.

In other forms, users can move navigational components around each tab. For example, a user may be able to drag-and-drop elements in a navigation bar into different positions within the bar, move the navigation bar itself to a different position in the view or tab, anchor the bar's or element's position within the application, or even make it appear as a view within a tab.

In another form, users can upload pictures, which can be framed or cropped for use and placement in a LifePage. Likewise, video can be uploaded or streamed to a server that puts all or a particular portion of the frame into a LifePage. If the user clicks on the framed video, its playback of the stream resumes where it left off. In one form, resizing a picture or video view causes more or less of the original picture or video to be shown, while in other forms resizing the view continues to show the same portion of the picture or video, but changes its magnification as needed to fill a view of the user's selected size.

In other forms, LifePage provides email access, a radio, and a jukebox, allows users to set “wallpaper” for views, tabs, or the whole application, and allows views to be set to stay in front of all other material in the tab. The “on top” settings are particularly useful for systems that display advertisements, so that the user can move the ad around the tab, but cannot resize it or place it under other views in z-order.

In another form, a local file browser (like a “My Computer” or “My Documents” application on a Microsoft WINDOWS system) is included within a LifePage view, allowing users to open files using local file associations and software applications, even displaying the application window as a LifePage view when the application can be embedded in that manner.

In still other forms, a portal operator collects fees from sponsors and/or users in exchange for providing a portal server and making available a view framework in which the sponsor can provide content protected from certain masking actions, managing authentication of end users, and the like.

Still other embodiments feature a “best of the web” library of pre-made collections of views each collection being a tab that users can add to their LifePages. Some categories are sponsored and include undeletable content, while others are shared (uploaded) by other users.

The improved system also allows users to reposition and resize pixel views, saving the new position or size information and restoring it when the user loads the view again.

In still other forms, a LifePage view embeds access to the user's email system in the view, either by providing access to a web mail site, by embedding an instance of all or part of the user's email application, or by other methods.

The system allows users to select wallpaper for views, categories, and/or the application itself. The wallpaper can simply be displayed behind all views in z-order, or it can be displayed with partial transparency (i.e., alpha blending) over the whole item or the content pane.

Still others load the initially shown tab of a LifePage when the LifePage is open, and then proceed to load content for views in hidden tabs in the background. That way, when a user selects another tab or display, the content is presented substantially instantaneously. Bandwidth limitations for the background loading can be imposed by a user in some embodiments, while in others individual views and/or tabs can be flagged for pre-loading while others are not.

### BRIEF DESCRIPTION OF THE DRAWINGS

FIG. 1 is a block diagram of a networked data system on which the illustrated embodiments operate.

FIG. 2 is a simulated screen shot of a sponsored LifePage according to a first illustrated embodiment.

FIG. 3 is a simulated screen shot of a wizard for adding a picture view or video view in the first illustrated embodiment.

FIG. 4 is a simulated screen shot illustrating personalized access enabled by the first illustrated embodiment.

FIG. 5 is a simulated screen shot illustrating a custom LifePage background in a first alternative embodiment.

FIG. 6 is a simulated screen shot illustrating a custom LifePage background in a second alternative embodiment.

FIG. 7 is a block diagram of a computer used in the first illustrated embodiment.

### DESCRIPTION

For the purpose of promoting an understanding of the principles of the present invention, reference will now be made to the embodiment illustrated in the drawings and specific language will be used to describe the same. It will, nevertheless, be understood that no limitation of the scope of the invention is thereby intended; any alterations and further modifications of the described or illustrated embodiments, and any further applications of the principles of the invention as illustrated therein are contemplated as would normally occur to one skilled in the art to which the invention relates.

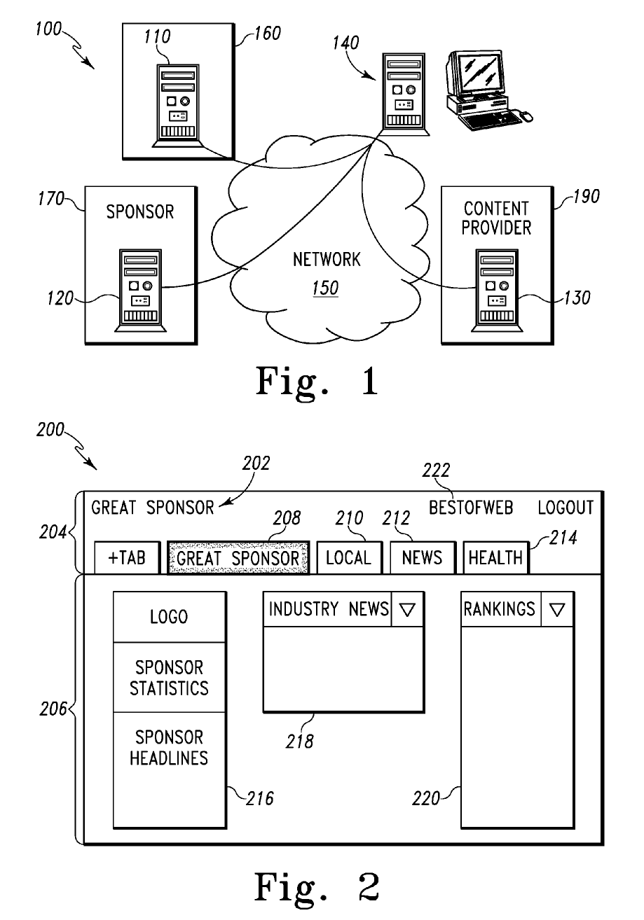

Generally, as shown in FIG. 1, one embodiment of the present invention employs at least four computers including portal server 110, sponsor content server 120, selected content server 130, and user's computer 140, all connected via data network 150 (such as the Internet) as system 100. Portal service provider 160 hosts and operates portal server 110 on behalf of sponsor 170 and other sponsors. Portal service provider 160 collects revenue 180 from sponsors 170 (or revenue 185 from users) in exchange for placement of fixed content on one or more LifePage tabs that are developed for users who sign up for service through sponsor 170. Additional content server 130 is operated by content provider 190 to the user of computer 140 without necessarily having cooperation of portal service provider 160 in that relationship. Other technological and financial arrangements may be made as discussed below and would occur to one skilled in the art.

After a user provides basic identifying information (such as authentication credentials to be used for future access), the user is shown an initial LifePage 200 that has been created by or for sponsor 170. A logo 202 for sponsor 170 appears in the upper corner of the page to promote brand recognition for sponsor 170, and the remainder of the upper portion 204 of the LifePage 200 is dedicated to navigation features. The lower portion 206 of LifePage 200 displays content.

In this embodiment, a “tabbed-style” interface is provided that includes sponsor tab 208, local information tab 210, news tab 212, and health information tab 214. In consideration for payment 108, sponsor tab 208 appears first at each login by the user, and sponsor view 216 appears permanently on the left side of the display under tab 208. Sponsor view 216 draws content from sponsor server 120 that in this embodiment includes content targeted for improving brand loyalty to, or patronage of sponsor 170. This content might include another logo, statistics related to sponsor 170 (such as stock prices of the company, win-loss record of a sports team, or the like), and news headlines that provide up to date information about sponsor 170. Other views shown under tab 208 include an industry news view 218 and rankings view 220, which are each drawn from content on other servers (for example, either sponsor server 120 or additional content server 130) using techniques shown in the LifePage Application. In this embodiment, the user can neither move nor cover sponsor pane 216 and cannot remove pane 218, though he or she can resize, move, and/or cover view 218.

In contrast, though tabs 210, 212, and 214 are pre-filled with content and views, users are much more free to adapt that content to their liking, or even to remove the tab entirely. New tabs can be added either as empty tabs to which the user adds content he specifies from anywhere on network 150 (and even specifies which part of the resource, either by choosing the desired portion of the document structure or the desired portion of the rendered page) or using a “Best of Web” library that is accessible via link 222 in upper portion 204 of LifePage display 200.

When a user selects the Best of Web link, the system presents a list of topics on which tabs have already been built and saved, then shared for use by others. The user can then customize the tab as desired, such as by adding additional views, removing views and content the user does not wish to see, reconfiguring the views (in size, shape, and z-order, for example), and the like.

In one alternative form of this embodiment, the user can share tab configurations that he or she has created, storing them on portal server 120 for retrieval by others using, for example, the user's identity, user name, tab name, key words in the tab name, metadata, or websites used in views in the tab. Once the tab is retrieved from the “Best of Web” library, the user can typically customize it as desired.

In some variations, however, creators or sponsors can choose to limit the changes that can be made to a tab after it is downloaded from the Best of Web library. For example, the sponsor of a library tab might force its own content to be displayed on top of other content, and prohibit it from being removed from the tab, both as consideration for the effort that goes into developing the tab and/or creating the content to be shown thereon.

In another exemplary application of this system, sponsor 170 is an employer who provides LifePage technology for its employees. In exchange for service fees 180, portal provider 160 hosts the portal framework on portal server 110 and manages authentication of users. In this application, custom sponsor content view 216 reflects employer-specific information and notices, such as personnel news, policy updates, and teaming information to encourage the employees. As in other applications of this technology, employee-users can add new views to additional LifePage tabs to facilitate retrieval of work-related content from around network 150. As one example, the employer provides all content in the initial “sponsor” tab 208, and allows employee-user content to appear on other tabs. In another example, employer-mandated content is limited to sponsor view 216, and employee-users are permitted to change or remove content in other views 218, 220, or even add additional views if they wish.

In another example, portal service provider 160 operates portal server 110 on behalf of a sports franchise 170 in exchange for payment of service fees 180. Fees may alternatively or additionally be collected from the fans (by portal provider 160 or sponsor organization 170). Sponsor tab 208 features the franchise logo, win-loss record, player trading news, line scores, and the like. Additional tabs or views within sponsor tab 208 are pre-programmed with league news and highlights, which the user can change, supplement, or delete as he or she chooses.

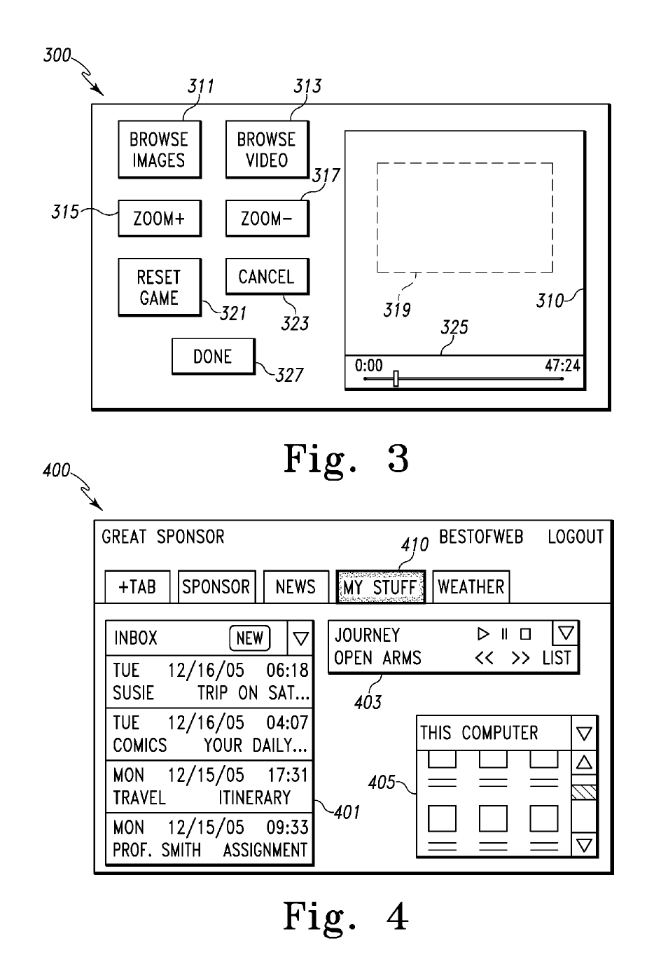

The “picture view” and “video view” features for use in a LifePage will now be described with reference to FIG. 3, and with continuing reference to the high-level elements shown in FIG. 1 these view types supplement the pixel views and parsed views described in the LifePage Application for use in tabs of LifePage 200. A user selects an image or video file, and that image (or a selected frame of the video) is shown in the center of display 300 in position 310. The user then operates on the image at region 310 using one or more of the buttons shown at the top of display 300. A different image or video can be selected using button 311 or 313, respectively. The image in region 310 can be zoomed-in using button 315 or zoomed-out with button 317. Scroll bars preferably appear along the right and bottom sides of region 310 when only a portion of the image or video frame is showing therein. If the user is selecting a video file, the video frame to be used in selecting the view port can be selected using arrow keys or the timeline that appears below region 310 at 325.

Once the image or frame is shown in region 310 at a sufficient level of magnification, the user drags his or her mouse to select a rectangle 319 around the portion of the image or video that the user wants to see in a view. After border 319 is selected, the user can adjust the edges individually by dragging the line (or adjust adjacent sides by dragging a corner) so that the selection is optimized for the user's preference. Zoom and selecting can be reset if the user selects button 321, and the whole view-adding process can be cancelled by a selection of Cancel button 323.

When the user is satisfied with the selection, he or she clicks Done button 327, and a “picture view” or “video view” showing the selected part of the image or video is added to the currently selected tab in LifePage 200. In some embodiments the image or video file being shown in the view is hosted on user's computer 140 and is accessed when the user displays the tab in which the picture view or video view is displayed. In others, the image or video is uploaded to portal server 110 or sponsor server 120 for better accessibility from other Internet-connected computers (not shown).

When a picture view or video view is displayed, and the user adjusts the size of the view shown in the tab, the system displays a correspondingly larger, smaller, or different portion of the picture or video. In others, the previously selected portion (which was indicated by rectangle 319 in FIG. 3) is simply magnified to be larger or smaller to fit the new size indicated by the user, preferably maintaining the aspect ratio of the originally selected rectangle 319. In still other embodiments, the user can select between these options as the view is being created, from the picture view or video view control menu, or both.

Another advance in this embodiment of LifePage is the ability of the user to adjust the position of a “pixel view” (see the LifePage Application) using scroll bars in the view, and let the new position (preferably automatically) be saved on the portal server. Then, the next time that tab is retrieved from portal server 110, the adjusted position controls the view so that the user's preferred content is displayed.

For video views, the user can play and pause stream simply by clicking on the video view. In some embodiments, the stream status is retained between sessions so that the stream resumes in a new session where it left off in the previous session. In other embodiments, the stream is reset each time the video view is loaded, so that the beginning of the stream is shown first in each session no matter where playback left off previously. In still others, where the stream is broadcasted substantially continuously, the stream resets to real-time streaming in each session, then may be paused and resumed by user command.

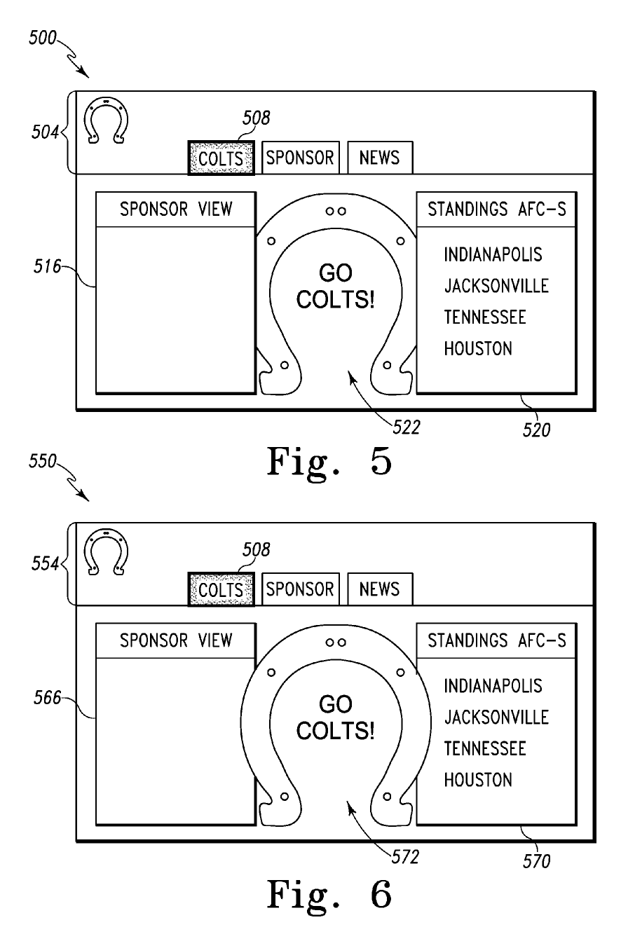

Additional available features are shown in LifePage 400, which is illustrated in FIG. 4. Tab 401 shows the user's email Inbox and enables the user to read received messages, write new messages, look up contact information from his or her existing database, manage tasks to be completed, and the like. Email view 401 may be an embedded control provided by the email program itself, a custom front end to a web mail interface, or other front end that would occur to one skilled in the art.

Jukebox view 403 plays audio files from the user's computer 110 whenever the selected tab 410 is shown on LifePage 400. Jukebox view 403 shows the artist and title of the track presently being played (based on ID3 data, for example) and permits the user to control playback of audio files in a playlist, as is understood in the art. Likewise, a “radio” view receives streaming music from sources selected by the user with a radio interface metaphor. A combination of this audio player with other features of the LifePage provides a heretofore unknown convenience and level of personalization for users, thereby improving their computing experiences in ways unique to them.

“This Computer” view 405 corresponds roughly to an integrated version of the “Windows Explorer” application of the WINDOWS operating system. Users navigate through resources available on the local computer using icons and optionally folder tree (not shown) navigation techniques to browse and/or search for locally available resources. “This Computer” view 405 employs locally applicable file type associations to let the user open files with the applications they normally use to manipulate or manage those files, such as using a word processor to edit files ending with a .doc extension, and using ADOBE READER to open files with a .pdf extension. When those associated applications make application windows available for embedding in other applications (such as by exposing a Common Object Model interface), such an embedded application window is placed in a new “embedded view” within the view framework. That embedded view can then be manipulated in size, position, tab placement, z-order setting, and the like just like other views in the framework. The position of the view and status of the underlying application persist between user sessions as well, thereby facilitating the user's further personalization of his or her LifePage.

FIG. 5 illustrates another LifePage 500, in which navigation section 504 includes a sponsor tab 508 for the Indianapolis Colts NFL team. Sponsor view 516 includes Colts promotional content, while standings view 520 shows the current standings for the American Football Conference south (which includes the Colts). Custom background image 522 appears behind all views on tab 508 and provides additional brand impressions for the sponsor.

FIG. 6 illustrates a similar usage of a background image 572 on the tab 558 of LifePage 550. Sponsor view 566 is comparable to sponsor view 516 in FIG. 5, and standings view 570 is comparable to standings view 520 in FIG. 5. Background image 572, however, appears over (not under) all views on tab 558, with an appropriate level of alpha blending to allow the content in those views to be seen through the image while the image remains always visible.

In other alternative embodiments, backgrounds can be selected by users and modified according to their preferences. In still others, the background graphic appears over all tabs and/or the whole application window, or just over the content of certain views.

In some alternative embodiments, the view framework provided by portal server 110 includes a pre-loading system that retrieves content for views other than the views on the first-shown tab. In one form, the user's application retrieves content for views in the initial tab first, then retrieves content that goes in views of other tabs in the user's LifePage. In other forms, content for hidden views is retrieved in parallel with content that is shown in the initially selected tab. In some variations, the user can set a maximum bandwidth level at which background loading is attempted, while in others the user can flag specific views and/or tabs for pre-loading (leaving others for loading on demand).

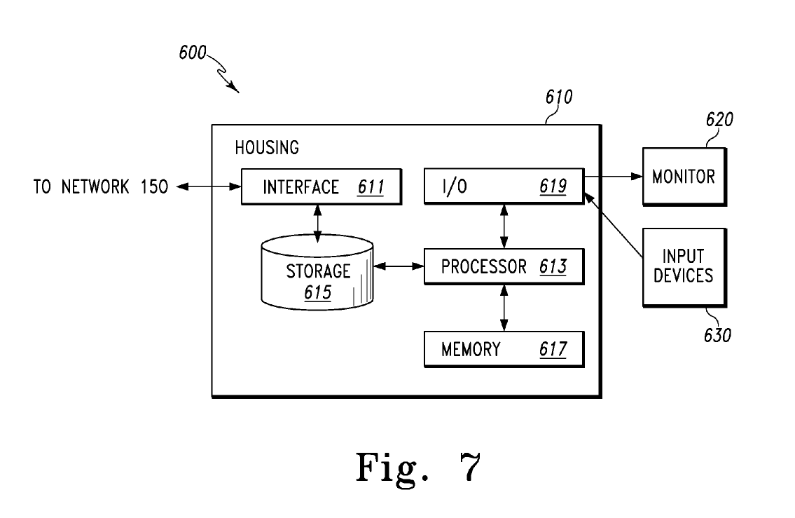

Computers in the illustrated embodiment, including user's computer 140 and servers 110, 120, and 130 each have one or more of the components shown in FIG. 7. In particular, the computer 600 includes housing 610, monitor 620, and input devices 630. Housing 610 houses network interface 611, which enables communication between computer 600 and other computing devices attached to network 150. Processor 613 communicates with interface 611 and other elements in housing 610 to execute programming instructions that accomplish the tasks described herein. Persistent storage unit 615 stores programming instructions, data, content, and the like as required by its place in system 100. Memory 617 provides temporary storage for processor 613, including storage of framework information, programming instructions, content, and the like. Input/output circuitry 619 provides an interface to local input and output devices such as input devices 630 (e.g., keyboard, mouse, voice input) and monitor 620.

Processor 613 is preferably a microcontroller or general purpose microprocessor that reads its program from memory 617. Processor 613 may be comprised of one or more components configured as a single unit. Alternatively, when of a multi-component form, processor 613 may have one or more components located remotely relative to the others. One or more components of processor 613 may be of the electronic variety defining digital circuitry, analog circuitry, or both. In one embodiment, processor 613 is of a conventional, integrated circuit microprocessor arrangement, such as one or more PENTIUM 4 or XEON processors from INTEL Corporation of 2200 Mission College Boulevard, Santa Clara, Calif., 95052, USA, or ATHLON XP processors from Advanced Micro Devices, One AMD Place, Sunnyvale, Calif., 94088, USA.

Likewise, storage 615 and memory 617 can include one or more types of solid-state electronic memory, magnetic memory, or optical memory, just to name a few. By way of non-limiting example, storage 615 and memory 617 can include solid-state electronic Random Access Memory (RAM), Sequentially Accessible Memory (SAM) (such as the First-In, First-Out (FIFO) variety or the Last-In First-Out (LIFO) variety), Programmable Read Only Memory (PROM), Electrically Programmable Read Only Memory (EPROM), or Electrically Erasable Programmable Read Only Memory (EEPROM); an optical disc memory (such as a recordable, rewritable, or read-only DVD or CD-ROM); a magnetically encoded hard disk, floppy disk, tape, or cartridge media; or a combination of any of these memory types. Also, storage 615 and memory 617 can be volatile, nonvolatile, or a hybrid combination of volatile and nonvolatile varieties.

While the invention has been illustrated and described in detail in the drawings and foregoing description, the same is to be considered as illustrative and not restrictive in character, it being understood that only the preferred embodiments have been shown and described and that all changes and modifications that would occur to one skilled in the relevant art are desired to be protected.

What is claimed is:

1. A system, comprising a memory and a processor in communication with the memory, the memory storing programming instructions executable by the processor to:
retrieve first web content from a first source selected by a user without limitation to a predetermined list of sources;
retrieve second web content from a second source specified by another party;
display the first web content in a first view and the second web content in a second view, both views being in a single application window; and
allow the user to move and resize the first view, and to identify third web content to replace the first web content in the first view; and
prevent the user from replacing the second web content in the second view.

2. The system of claim 1, wherein the programming instructions are executable by the processor to limit the user to a limited set of view configurations that do not conceal any part of the second web content behind the first view.

3. A method of doing business, comprising:
a service provider hosting a portal server;
a sponsor paying the service provider;
the portal server providing a view framework to users;
the users using the view framework:
to display visual content in at least one user view, and
to move and resize the user view; and
the view framework displaying sponsor-specified content, while preventing the users from obscuring the sponsor-specified content with the user view.

4. The method of claim 3, wherein the view framework also enables users to add an additional view to display content identified by the user.

5. The method of claim 3, wherein the visual content in at least one user view is not selected from a predetermined list.

6. The method of claim 3, wherein the service provider does not host the sponsor content.

7. The method of claim 3, wherein the service provider does not host the visual content.

8. The method of claim 7, wherein each user hosts the visual content in the user's view.

9. The method of claim 3, wherein the view framework:
employs a tabbed interface that includes a first tab and a second tab;
displays the sponsor-specified content in the first tab; and
displays the first tab first when the view framework loads.

10. A system, comprising a memory and a processor in communication with the memory, the memory storing programming instructions executable by the processor to:
display a LifePage;
add a view to the LifePage that shows a user-specified portion of an image or video retrieved from the user's local computer; and
enable the user to resize the view, thereby causing a zoomed form of the user-specified portion of the image to be shown in the view.
